(19) United States
(12) Patent Application Publication
(10) Pub. No.: US 2018/0229124 A1
(43) Pub. Date: Aug. 16, 2018

(54) Method Combining Learning Academic with Electronic Game Playing

(71) Applicants: Guo Song Hu, Toronto (CA); William Zhijing Hu, Toronto (CA)

(72) Inventors: Guo Song Hu, Toronto (CA); William Zhijing Hu, Toronto (CA)

(21) Appl. No.: 15/429,279

(22) Filed: Feb. 10, 2017

(51) Int. Cl. A63F 13/55; A63F 13/63; A63F 13/822

(52) U.S. Cl. CPC A63F 13/55; A63F 13/822; A63F 13/63

(57) ABSTRACT

A method of learning academic in game playing in electronic games. The method includes gaining experience points by answering academic questions or resolve intelligence problems correctly, getting a level up by answering academic questions or resolve intelligence problems correctly, learning skills/abilities by answering academic questions or resolve intelligence problems correctly, collecting resources by answering academic questions or resolve intelligence problems correctly, getting access to an object or disarm a trap by answering academic questions or resolve intelligence problems correctly, and equipping an article by answering academic questions or resolve intelligence problems correctly.

### CROSS-REFERENCE TO RELATED APPLICATIONS

This application claims priority to U.S. Provisional Application Ser. No. 62/448,417, entitled “A Method of Learning Academic in Game Playing in Electronic Game” file led Jan. 31, 2017, the disclosure of Which is hereby expressly incorporated herein by reference.

### BACKGROUND OF THE INVENTION

Learning in the game playing is the best way to learn. Almost every kid likes to play electronic games, but most of parents want their kids to study instead of playing games at the mean time. Nowadays we have both games and learning software, but really good RPC, strategy, and turn-based tactics games, such as “World of Warcraft” series, and “Super Mario” series, “Heroes of Might and Magic” series, with fighting, experience point earning, abilities (such as tailoring and blacksmithing) and skills and abilities (such as attack and defense) learning, and resource (such as gold and minerals) collecting, that kids like to play are pure games without any direct relations to academic learning.

In current existing electronic games (computer games, mobile device games, play stations, Xbox, handheld game devices, etc.), players gain experience points purely by fighting. Also players get a level up automatically when they have reached the experience points needed for a level up. Furthermore when players learn the skills/abilities after they have the needed level or points, they can select the skills and abilities, and the skills/abilities are granted right away. The purpose of the invention is to combine the game playing and academic learning seamlessly by forcing the players to answer academic questions correctly in level up, skill/ability learning, resource collecting, article equipping, and trap disarming. The players also can gain experience points by learning (answering academic question correctly).

The inspiration of the invention comes from the conflict of father and son when my son played computer games. We realized that such an invention can match the needs of both sides.

### BRIEF SUMMARY OF THE INVENTION

This invention relates to methods for gaining experience points, skills/abilities learning and level up, in electronic games (computer games, mobile device games, and other games with an electronic user interfaces). Specifically, this invention relates to: (1) the players gain experience points by correctly answering academic questions or resolving academic problems in math, science, biology, language, music, and other subjects; (2) the players only get level up after they have correctly answered the academic questions or successfully resolve academic problems in math, science, biology, language, music, and other subjects even though the players have enough experience points; (3) The players must resolve the academic problem or answer the academic question correctly to obtain some special skills/abilities. (4) the players must resolve the academic problem or answer the academic question correctly to get the ability to use a weapon or equipment even he/she already bought or obtained the weapon or equipment, (5) the players must resolve the academic problem or answer the academic question correctly to get access to an object (such as a secret door or building); and (6) the players must resolve the academic problem or answer the academic question correctly to collect a resource (such as gold and minerals). The invention is applicable to all electronic games involving a display screen or graphical user interface.

### BRIEF DESCRIPTION OF THE DRAWINGS

A clear understanding of the key features of the invention summarized above may be had by reference to the appended drawings, which illustrate the methods of the invention, although it will be understood that such drawings depict preferred embodiments of the invention and, therefore, are not to be considered as limiting its scope with regard to other embodiments which the invention is capable of contemplating. Accordingly:

FIG. 1. FIG. 1 illustrates an example scenario of the method to gain experience points by academic learning instead of fighting.

FIG. 2. FIG. 2 illustrates an example scenario of the method to learn a skill/ability by answering academic question correctly or resolve academic problems.

FIG. 3. FIG. 3 illustrates an example scenario of the method to get a level up by answering academic question correctly or resolve academic problems after the player has reached experience points needed for the level.

FIG. 4. FIG. 4 illustrates an example scenario of the method to collect a resource by answering academic question correctly or resolve academic problems.

FIG. 5. FIG. 5 illustrates example scenario of the method to get access to an object (such as a door or building) by answering academic question correctly or resolve academic problems.

FIG. 6. FIG. 5 illustrates example scenario of the method to get the ability to use equipment (such as a sword or a shield) by answering academic question correctly or resolve academic problems.

FIG. 7. FIG. 7 illustrates an example scenario of the method to disarm a trap by answering academic question correctly or resolve academic problems.

### DETAILED DESCRIPTION OF THE PREFERRED EMBODIMENTS

Games: Games referenced in this invention can be electronic games playing on a PC, a Mac, a laptop, a mobile device such as a smart phone or tablet, a play station, an Xbox, a Wii device, or any other electronic devices displaying games on a screen or a VR glasses in the genres of role paly games, strategy games, action-adventure games, adventure games, and simulation games of both online and offline.

User Interfaces: User interfaces referenced in this invention can be any kinds of user interfaces, such as graphical user interface, VR interface, voice conversation interface, in electronic games. What the invention focuses is that the players earn experience points, get level up, learn skills/abilities, collect resources, and get access to an object or disarm traps, by answering academic questions correctly.

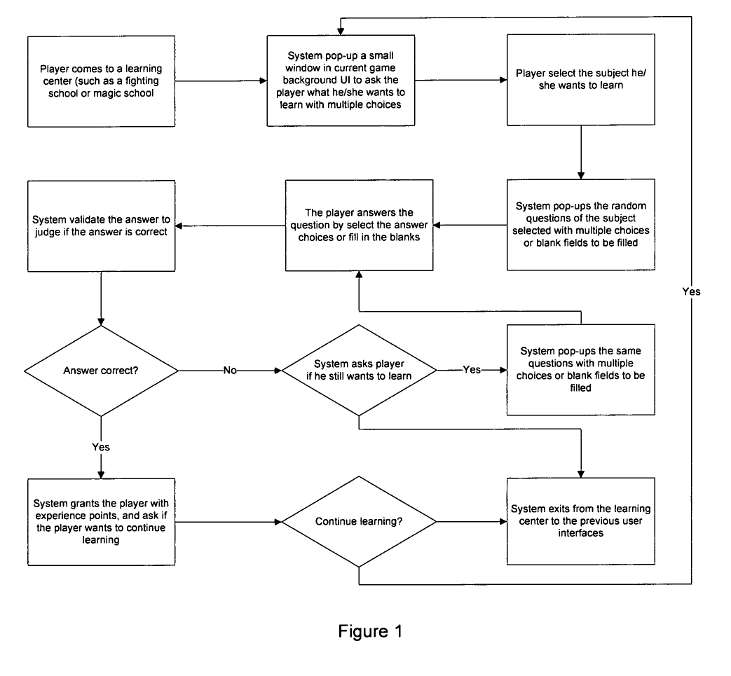

FIG. 1 is demonstrates how a game player earns experience points by learning (answering academic questions) instead of fighting. For example, in a RPC game a player comes to a learning center (such as a fighting school or magic school), the system pop-ups a small window in current game background user interface to ask the player what he/she wants to learn with multiple choices of subjects (such as English, Mathematics, Science, Physics, Chemistry, Geography, History, etc.). The player selects the subject, and the system pop-ups the random questions with multiple choices or blank fields to be filled within the subject selected by the player. The player answers the question by selecting the answer choices or filling in the blanks. The system validates the answers provided by the player. If the answers are correct, the system tells the player how many experience points he has earned, and asks if the player wants to continue the learning. If the player selects to continue learning, the system will pop-ups a new question and continues the loop. If the player selects to stop learning, the system exits to the previous screen that the player in front of the learning center. If the answers are wrong, the system will ask the player if he wants to give another try or just give up. The system will return to the screen of displaying the same question with multiple choices or blank fields if the player selects to continue trying, and repeat the above loop. If the player selects to stop trying, the system exits to the previous user interface that the player in front of the learning center. In this processes, the pop-up user interface may be replaced by voice conversation.

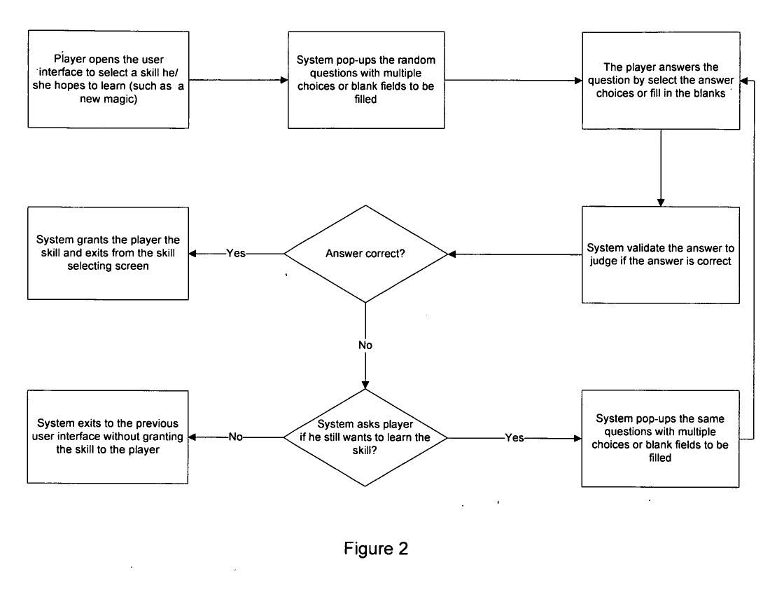

FIG. 2 demonstrates how a game player learns a new skill/ability by answering academic questions correctly. For example in a RPC game the player triggers the user interface to select a skill he/she hopes to learn (such as increase an attack point, or a new magic), and the system pop-ups the random academic questions of a given subject (such as English, Mathematics, Science, Physics, Chemistry, Geography, History), with multiple choices or blank fields to be filled. The player answers the question by selecting the answer choices or filling in the blanks. The system validates the answers to validate whether the answers are correct. If the answers are correct, the system grants the player the skill and exits from the skill learning user interface to the previous user interface. If the answers are wrong the system asks whether the player wants another try. If the player selects to try again, the system displays the same question with multiple choices or blank fields to be filled. The player selects answers or fills in the blanks, and repeats the above loop. If the player selects to stop trying, the system exits from the skill learning user interface to the previous user interface without granting the player the skill. In this processes, the pop-up user interface may be replaced by voice conversation.

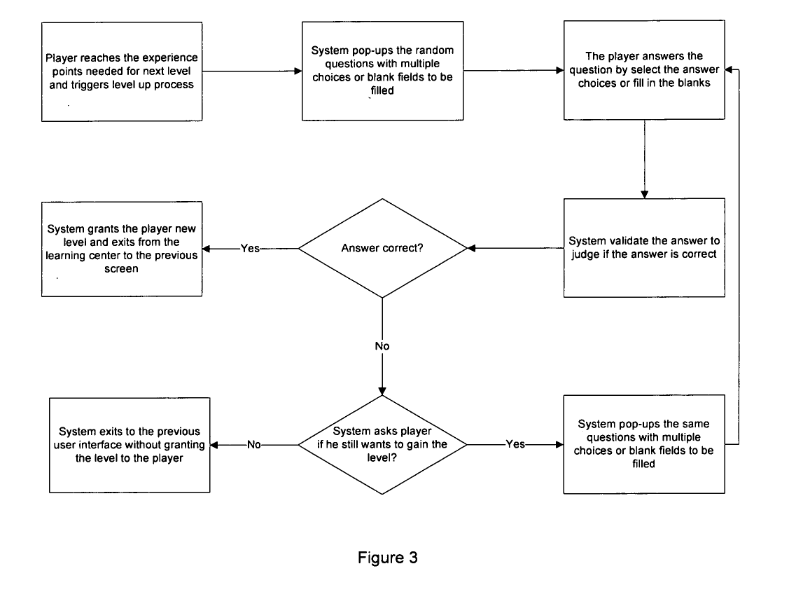

FIG. 3 demonstrates how a game player gets a level up by answering academic questions correctly. For example in a RPC game, the player reaches the experience points needed for next level and triggers level up user interface, the system pop-ups the random academic question of a given subject (such as English, Mathematics, Science, Physics, Chemistry, Geography, History) with multiple choices or blank fields to be filled. The player answers the question by selecting the answer choices or filling in the blanks. The system validates the answers to validate whether the answers are correct. If the answers are correct, the system grants the player a level up and exits from the question answer user interface. If the answers are wrong, the system asks the player whether he/she wants to try again. If the player selects to try again, the system pop-ups the same question with multiple choices or blank fields to be filled, and the player answers the question again and repeat the above loop. If the player selects to stop trying, the system will exits from the question answer user interface without granting the player a level up. In this processes, the pop-up user interface may be replaced by voice conversation.

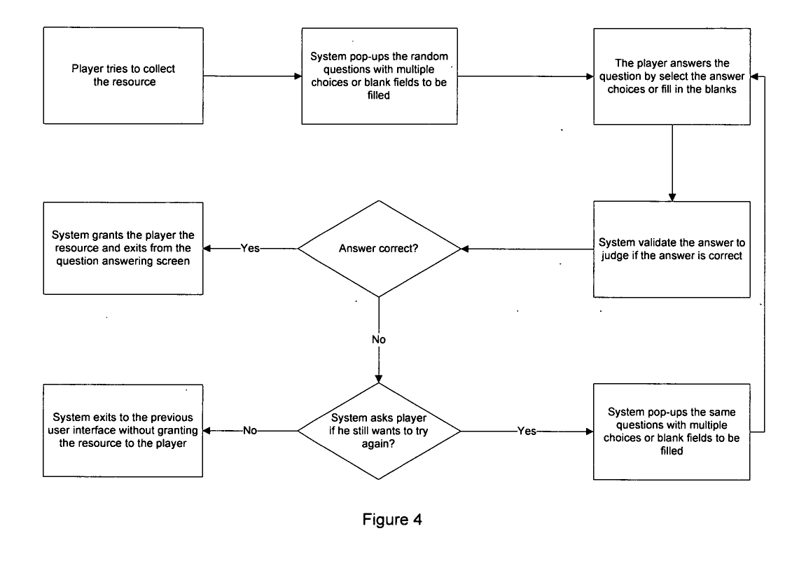

FIG. 4 demonstrates how a game player collects a resource such as gold coins by answering academic questions correctly. For example in a RPC game the player touches the gold coins he/she wants to collect. The system pop-ups the random academic questions in a given subject (such as English, Mathematics, Science, Physics, Chemistry, Geography, History), with multiple choices or blank fields to be filled. The player answers the question by selecting the answer choices or filling in the blanks. The system validates the answer to validate whether the answers are correct. If the answers are correct, the system grants the player the gold coins and exits from the question answer user interface to the previous user interface. If the answers are wrong the system asks whether the player wants another try. If the player selects to try again, the system displays the same question with multiple choices or blank fields to be filled. The player selects answers or fills in the blanks, and repeats the above loop. If the player selects to stop trying, the system will exits from the question answer screen to the previous user interface without granting the player the gold coins. In this processes, the pop-up user interface may be replaced by voice conversation.

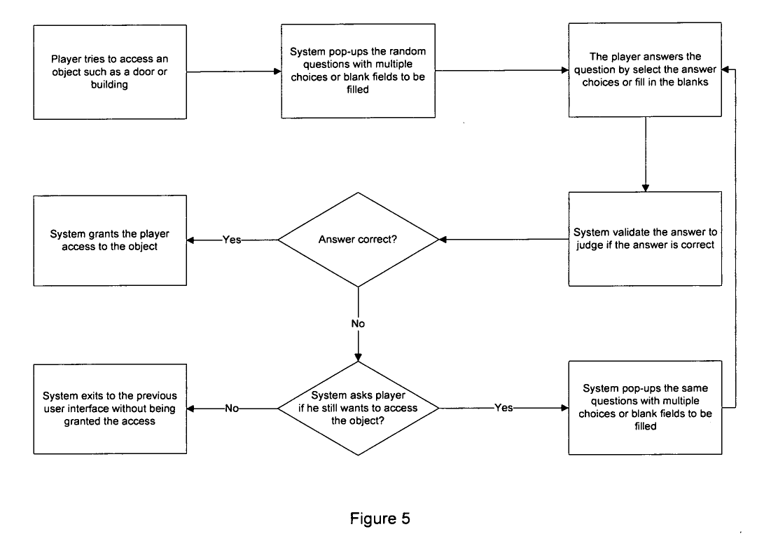

FIG. 5 demonstrates how a game player gets access to an object such as a door or building. For example in a RPC game, a player tries to explore a tomb by touching the tomb door. The system pop-ups academic question in a given subject (such as English, Mathematics, Science, Physics, Chemistry, Geography, History) with multiple choices or blank fields to be filled. The player answers the question by selecting the answer choices or filling in the blanks. The system validates the answer to validate whether the answers are correct. If the answers are correct, the system grants the player access to the tomb, and opens a new graphical user interface to display the tomb inside. If the answers are wrong, the system asks the player whether he wants to try again. If the player selects to try again, the system displays the same question. The player answers the question, and repeats the above loop. If the player selects to stop trying, the system will not grant the player access to the tomb, exit from the question answer user interface, and return to the previous user interface before touching the tomb door.

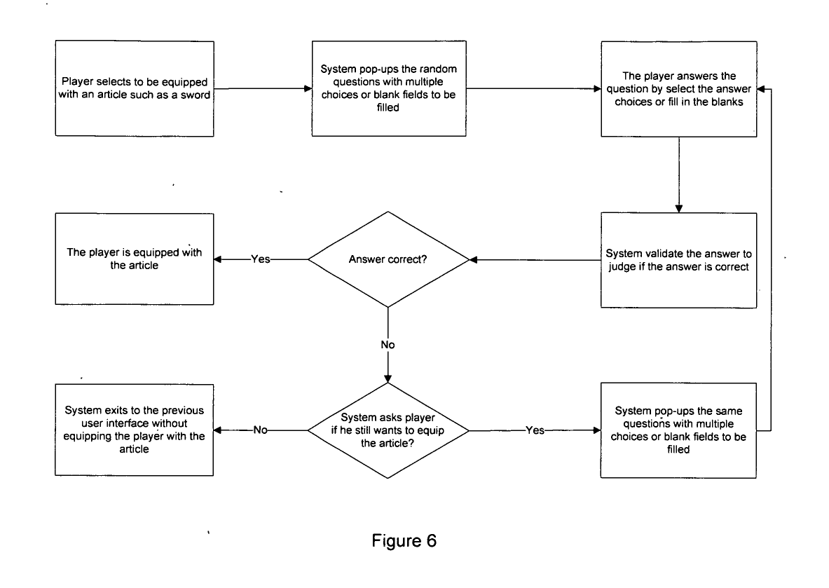

FIG. 6 demonstrates how a game player is equipped with a game article such as a sword or shield with academic learning. For example in a RPC game, a player opens the user interface to arm an article. He selects a sword, the system pop-ups academic question in a given subject (such as English, Mathematics, Science, Physics, Chemistry, Geography, History) with multiple choices or blank fields to be filled. The player answers the question by selecting the answer choices or filling in the blanks. The system validates the answer to validate whether the answers are correct. If the answers are correct, the system arms the player with the sword. If the answers are wrong, the system asks the player whether he wants to try again. If the player selects to try again, the system displays the same question. The player answers the question, and repeats the above loop. If the player selects to stop trying, the system will not arm the player with the sword, and the player can selects to arm with another article, or just exits from the equipment interface.

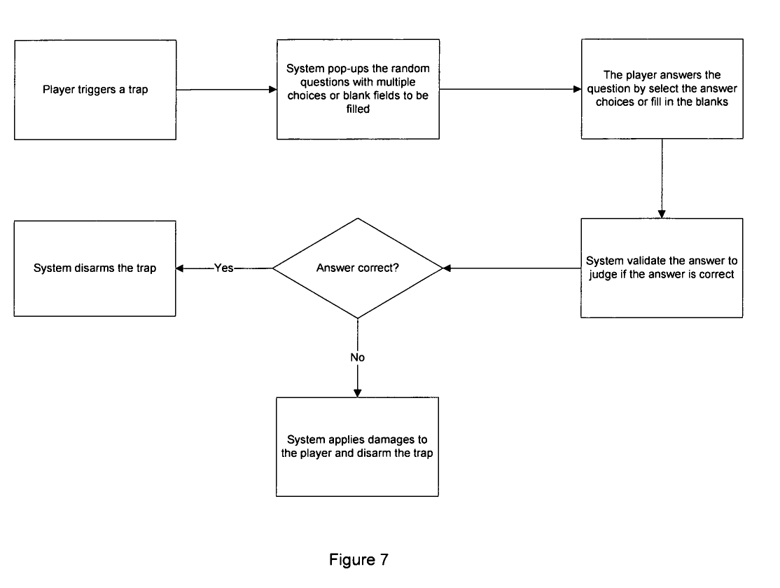

FIG. 7 demonstrates how a game player disarms a trap such as a bomb. For example in a RPC game, a player triggers a trap of a bomb. The system pop-ups academic question in a given subject (such as English, Mathematics, Science, Physics, Chemistry, Geography, History) with multiple choices or blank fields to be filled. The player answers the question by selecting the answer choices or filling in the blanks. The system validates the answer to validate whether the answers are correct. If the answers are correct, the system disarms the bomb. If the answers are wrong, the system applies some given damages to the player, and disarms the bomb.

The invention has been described in terms of several preferred embodiments above. But it would be understood that various modification may be made. Such as the player will must answer more than one question correctly before a skill is granted. So it will be appreciated that the invention may be embodied without departing from the fair scope of the invention defined by the following claims.

What is claimed is:

1. A method of learning academic in game playing in electronic games (for example, RPC games, strategy games, and turn-based tactics games, etc.) by forcing players to answer academic question in school subjects (for example math, science, biology, languages, etc.) before granting experience points, level up, skills/abilities, resources, access to an object (for example, a secret door, a building, etc.), and disarm a trap.

2. The method of claim 1, further including the process of gaining experience points by answering academic questions or resolve academic problems in electronic games.

3. The method of claim 1, further including the process of learning a skill/ability by answering academic questions correctly or resolving academic problems correctly in electronic games.

4. The method of claim 1, further including the process of getting a level up by answering academic questions correctly or resolving academic problems correctly in electronic games.

5. The method of claim 1, further including the process of collecting resources by answering academic questions correctly or resolving academic problems correctly in electronic games.

6. The method of claim 1, further including the process of getting access to an object by answering academic questions correctly or resolving academic problems correctly in electronic games.

7. The method of claim 1, further including the process of equipping an article such as a sword by answering academic questions correctly or resolving academic problems correctly in electronic games.

8. The method of claim 1, further including the process of disarming a trap by answering academic questions correctly or resolving academic problems correctly in electronic games.

9. The method of claim 2, further including the process comprising the steps that:
the player selects subject category of learning;
the system displays question with answers of multiple choices or blanks to be filled;
the player answers the question by checking choices of filling the blanks;
the system validates whether the answers are correct;
the player selects to continue trying or to stop learning; and
the player will be granted with experience points only when if the answers are correct.

10. The method of claim 3, further including the process comprising the steps that:
the system displays question with answers of multiple choices or blanks to be filled;
the player answers the question by checking choices or filling the blanks;
the system validates whether the answers are correct;
the player selects to continue trying or to give up trying to answer the question; and
the player will not be grated with the skill/ability if the answers are wrong and the player selects to give up trying.

11. The method of claim 4, further including the process comprising the steps that:
the system displays question with answers of multiple choices or blanks to be filled;
the player answers the question by checking choices or filling the blanks;
the system validates whether the answers are correct;
the player selects to continue trying or to give up trying to answer the question; and
the player will not be grated the level up if the answers are wrong and the player selects give up trying.

12. The method of claim 5, further including the process comprising the steps that:
the system displays question with answers of multiple choices or blanks to be filled;
the player answers the question by checking choices or filling the blanks;
the system validates whether the answers are correct;
the player selects to continue trying or to give up trying to answer the question; and
the player will not be grated with the resource if the answers are wrong and the player selects to give up trying.

13. The method of claim 6, further including the process comprising the steps that:
the system displays question with answers of multiple choices or blanks to be filled;
the player answers the question by checking choices or filling the blanks;
the system validates whether the answers are correct;
the player selects to continue trying or to give up trying to answer the question; and
the player will be declined to access the object if the answers are wrong and the player selects to give up trying.

14. The method of claim 7, further including the process comprising the steps that:
the system displays question with answers of multiple choices or blanks to be filled;
the player answers the question by checking choices or filling the blanks;
the system validates whether the answers are correct;
the player selects to continue trying or to give up trying to answer the question; and
the player will not be equipped with the article if the answers are wrong and the player selects to give up trying.

15. The method of claim 8, further including the process comprising the steps that:
the system displays question with answers of multiple choices or blanks to be filled;
the player answers the question by checking choices or filling the blanks;
the system validates whether the answers are correct; and
the system will disarm the trap without applying any damage to the player if the answers are correct, and with applying damages to the player if answers are wrong.
